(19) United States
(12) Patent Application Publication
(10) Pub. No.: US 2016/0373268 A1
(43) Pub. Date: Dec. 22, 2016

(54) INFORMATION PROCESSING SYSTEM, INFORMATION PROCESSING METHOD, AND STORAGE MEDIUM

(71) Applicant: FUJITSU LIMITED, Kawasaki-shi (JP)

(72) Inventor: Naoki MATSUOKA, Kawasaki (JP)

(73) Assignee: FUJITSU LIMITED, Kawasaki-shi (JP)

(21) Appl. No.: 15/180,343

(22) Filed: Jun. 13, 2016

(30) Foreign Application Priority Data
Jun. 22, 2015 (JP) 2015-124930

(51) Int. Cl. H04L 12/18; H04L 29/12; H04L 12/24

(52) U.S. Cl. CPC H04L 12/1886; H04L 41/0816; H04L 41/082; H04L 61/103

(57) ABSTRACT

An information processing system includes a plurality of devices; a relay device configured to relay communication between the terminal device and the plurality of devices; and a management device configured to manage the plurality of devices and the relay device, wherein the relay device is configured to: receive an access request for requesting access to a target device from the terminal device, and broadcast a request packet for acquiring identification information that identifies the target device to the network, the request packet including a network address of the target device, and wherein the management device is configured to: receive the request packet, identify the target device out of the plurality of devices, based on the network address of the target device, acquire configuration information from the identified target device, and update configuration management information including configuration information of each of the plurality of devices using the acquired configuration information.

### CROSS-REFERENCE TO RELATED APPLICATION

This application is based upon and claims the benefit of priority of the prior Japanese Patent Application No. 2015-124930, filed on Jun. 22, 2015, the entire contents of which are incorporated herein by reference.

### FIELD

The embodiments discussed herein are related to an information processing system, an information processing method, and a storage medium.

### BACKGROUND

In an information processing system, a plurality of infrastructure devices, for example, a server, storage, and so on work in concert over a network to attain an operating objective of the system. In the information processing system, a configuration management system for managing a plurality of infrastructure devices is employed. To cause the information processing system to operate as intended, the configuration management system manages configuration information such as information related to physical requirements, design, and operation of the information processing system. If a change has occurred in a configuration or setting (hereinafter collectively referred to as a configuration change) in the information processing system, the configuration management system stores the content of the change in the configuration in the configuration management system. Further, the configuration management system may efficiently control the change in the information processing system by checking whether the content of the change is actually reflected in the information processing system.

A system is known in which an address monitor agent monitors a domain name service (DNS) and, if a change has occurred in the setting details, issues a notification to an address information monitor manager, and thus, consistency of address information is maintained in the system with the address information monitor manager (for example, see Japanese Laid-open Patent Publication No. 2004-147132).

A system is known in which, in order to manage devices coupled to a network, IP addresses corresponding to devices in the system are searchable (for example, see Japanese Laid-open Patent Publication No. 2007-221565).

A method is known in which data packets transmitted over a network are monitored in order to cause a router to reflect the configuration of devices coupled to the network (for example, see Japanese National Publication of International Patent Application No. 2005-513832).

Among asset management systems that manage assets in systems, a system to reduce the load is known (for example, see Japanese Laid-open Patent Publication No. 2009-301409). This system determines the loads of a server, which includes an asset management manager, and a configuration information management database, and, based on the determination, permits or does not permit transmission of configuration information.

A configuration management system that regularly collects configuration information from infrastructure devices in an information processing system, for example, through polling, thus manages the latest configuration information of the infrastructure devices. However, if the maintainer changes the configuration of the infrastructure devices, the configuration information managed by the configuration management system will be inconsistent with the actual configuration information of infrastructure devices until regular processing for collecting the content of the change is performed by the configuration management system.

When the maintainer changes the configuration of infrastructure devices in the environment where the time intervals at which the configuration management system collects the latest configuration information are long, the period of time during which the configuration information managed by the configuration management system is inconsistent with the actual configuration information of infrastructure devices is likely to be long. In contrast, when the time interval at which the configuration management system collects the latest configuration information is reduced, there is a possibility that the loads on the configuration management system and infrastructure devices will be increased. Further, the network is more likely to be congested. Therefore, it is desirable to reduce the period of time during which inconsistency between the configuration information managed by the configuration management system and the actual configuration information of the infrastructure devices occurs.

### SUMMARY

According to an aspect of the invention, an information processing system includes a plurality of devices coupled to one another via a network; a relay device coupled to a terminal device and configured to relay communication between the terminal device and the plurality of devices; and a management device configured to manage the plurality of devices and the relay device, wherein the relay device is configured to: receive an access request for requesting access to a target device from the terminal device, and broadcast a request packet for acquiring identification information that identifies the target device to the network, the request packet including a network address of the target device, and wherein the management device is configured to: receive the request packet, identify the target device out of the plurality of devices, based on the network address included in the request packet, acquire configuration information from the identified target device, and update configuration management information including configuration information of each of the plurality of devices using the acquired configuration information.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of an information processing system according to a first embodiment;

FIG. 2 is a diagram illustrating an example of a hardware configuration of a configuration management device;

FIG. 3 is a diagram depicting an example of a device DB;

FIG. 4 is a diagram depicting an example of a configuration management DB;

FIG. 5 is a diagram illustrating an example of a format of an ARP request packet;

FIG. 6 is a sequence diagram illustrating an example of processing of an information processing system according to the first embodiment;

FIG. 7 is a flowchart illustrating an example of processing of the configuration management device according to the first embodiment;

FIG. 8A is a sequence diagram illustrating an example of processing of an information processing system according to a second embodiment;

FIG. 8B is a sequence diagram illustrating an example of processing of the information processing system according to the second embodiment;

FIG. 9 is a diagram illustrating an example of a format of a GARP packet;

FIG. 10 is a flowchart illustrating an example of processing of the information processing system according to the second embodiment;

FIG. 11 is a diagram illustrating an example of an information processing system according to a third embodiment;

FIG. 12 is a sequence diagram illustrating an example of processing of the information processing system according to the third embodiment;

FIG. 13 is a diagram illustrating an example of information transmitted from the configuration management device to a configuration management server;

FIG. 14 is a flowchart illustrating an example of processing of a configuration management device according to the third embodiment;

FIG. 15A is a sequence diagram illustrating an example of processing of an information processing system according to a fourth embodiment; and

FIG. 15B is a sequence diagram illustrating an example of processing of the information processing system according to the fourth embodiment.

### DESCRIPTION OF EMBODIMENTS

Hereinafter, with reference to the accompanying drawings, embodiments will be described in detail.

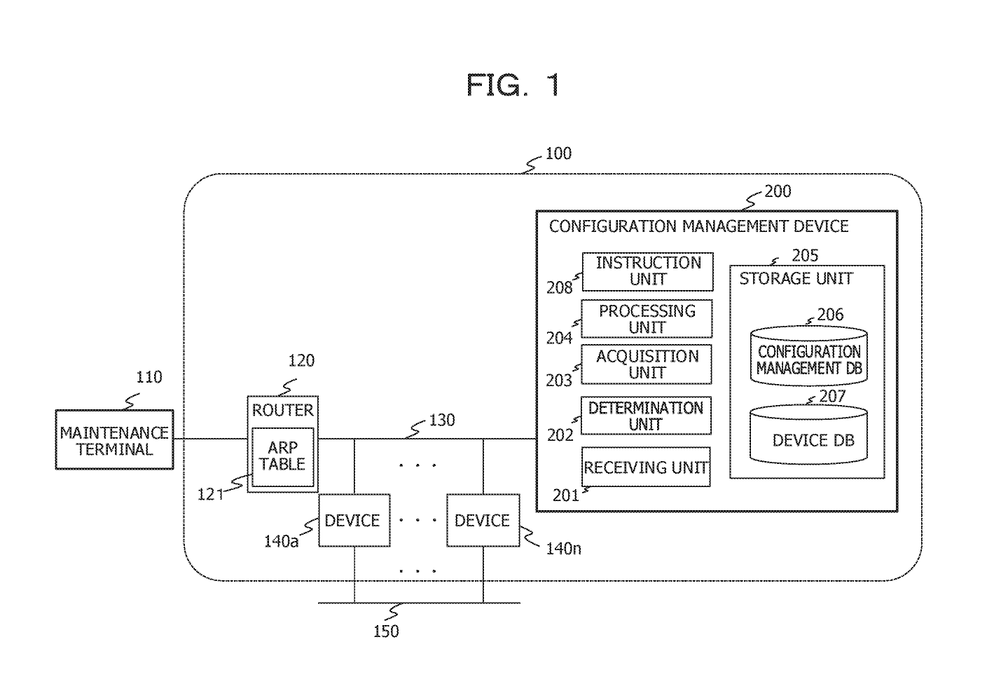

FIG. 1 is a diagram illustrating an example of an information processing system according to a first embodiment. An information processing system 100 includes a router 120, a management local area network (LAN) 130, a configuration management device 200, and a device 140a to a device 140n. The router 120 is a relay device that couples the management LAN 130 to a network including a maintenance terminal 110. The device 140a to the device 140n are infrastructure devices (hereinafter, the device 140a to the device 140n are also collectively as devices 140). The device 140 is sometimes referred to as a device. The configuration management device 200 is a device that manages configuration information of the router 120 and the device 140a to the device 140n. The management LAN 130 is coupled so that the configuration management device 200 manages the router 120 and the device 140a to the device 140n. The configuration management device 200 includes a receiving unit 201, a determination unit 202, an acquisition unit 203, a processing unit 204, and a storage unit 205. Specific processing of components will be described in (1) to (8) below. The storage unit 205 includes a configuration management database (DB) 206 and a device DB 207. The device DB 207 stores Internet protocol (IP) addresses and media access control (MAC) addresses corresponding to the router 120 and the device 140a to the device 140n that the configuration management device 200 manages. The configuration management DB 206 stores the IP addresses, the MAC addresses, and the configuration information of the router 120 and the device 140a to the device 140n.

The information processing system 100 is accessible from the maintenance terminal 110. The maintenance terminal 110 is a terminal used when the maintainer operates the devices 140. The maintainer may access the devices 140 through the router 120 and the management LAN 130 by using the maintenance terminal 110. A business LAN 150 is a LAN for access to the devices 140 and is used for access for a purpose different from management.

Hereinafter, a process related to the information processing system 100 according to the first embodiment will be sequentially described.

(1) The maintenance terminal 110 transmits an access request for access to an IP address to be accessed that is input by the maintainer, to the router 120.

(2) The router 120 broadcasts an address resolution protocol (ARP) request packet to the device 140a to the device 140n and the configuration management device 200 on the management LAN 130. The ARP request packet is transmitted so that the router 120 acquires a MAC address corresponding to the IP address of the device 140 to be accessed. In other words, the ARP packet is a packet for requesting address resolution (an address resolution request packet).

(3) The ARP request packet transmitted from the router 120 is broadcast on the management LAN 130. That is, this ARP request packet arrives at not only the device 140a to the device 140n but also the configuration management device 200. Consequently, the receiving unit 201 in the configuration management device 200 receives the ARP request packet transmitted from the router 120.

(4) The determination unit 202 first determines whether or not the received packet is an ARP request packet. Next, the determination unit 202 determines the IP address contained in the ARP request packet. Specifically, the determination unit 202 determines whether or not the transmission source of the ARP request packet is the router 120. Further, the determination unit 202 determines whether or not the value of the target IP address (the destination IP address) of the ARP payload in the ARP request packet is the IP address of the device 140 that the configuration management device 200 manages. In other words, it is determined whether or not the transmission source of the ARP request packet is the router 120 and the destination IP address is the IP address of the device 140 being managed by the configuration management device 200.

(5) If the transmission source of an ARP request packet is the router 120, and the destination IP address is the IP address of the device 140 being managed by the configuration management device 200, the determination unit 202 determines that the configuration change for the device 140 has been made. In this case, the determination unit 202 transmits an instruction to the acquisition unit 203 to acquire the configuration information of the device 140 to be accessed. For example, if the IP address of the device 140a is stored in the payload of the received ARP request packet, the determination unit 202 gives an instruction to the acquisition unit 203 instructing the acquisition unit 203 to acquire the configuration information of the device 140a.

(6) The acquisition unit 203 acquires the configuration information of the device 140 to be accessed. At this point, for example, the acquisition unit 203 requests the target device to offer the configuration information. Further, in response to the request, the target device transmits the configuration information to the configuration management device 200. It is preferable that the acquisition unit 203, after receiving the instruction, estimate the maintenance time actually taken by the maintainer and wait for a given period of time and then acquire the configuration information of the device 140 to be accessed.

(7) The processing unit 204 causes the configuration management DB 206 in the storage unit 205 to reflect the acquired configuration information. That is, the configuration information of the target device is updated with the newly acquired configuration information. Consequently, disagreement between the configuration information actually set in the target device and the configuration information managed by the configuration management device 200 is resolved.

(8) The instruction unit 208 transmits an instruction to delete or initialize an entry related to the device 140 to be accessed included in the ARP table 121 in the router 120, to the router 120. According to the received instruction, the router 120 deletes or initializes the entry related to the device 140 to be accessed in the ARP table 121. The ARP table 121 is an association information table storing the IP addresses and the MAC addresses of the devices 140 in association with each other. The router 120 may perform address resolution for access with a specified IP address based on the ARP table 121 by storing the IP addresses and the MAC addresses of the devices 140 in association with each other in the ARP table 121. However, if the entry related to the device 140 to be accessed is deleted in the processing of (8) and thus access from the maintenance terminal 110 to this device 140 is provided, the router 120 is able to transmit an ARP request packet again.

As described above, the configuration management device 200 may detect that a configuration change will be made for the device 140 being managed and to be accessed, by analyzing an ARP request packet transmitted from the router 120. Thereafter, the configuration management device 200 acquires the latest configuration information from the device 140 for which the configuration information has been changed. That is, immediately after the configuration information of the device 140 is changed, the configuration management device 200 may acquire the latest configuration information from that device 140. Thus, the configuration management device 200 may reduce the period of time during which inconsistency between the configuration information managed by the configuration management system and the actual configuration information of infrastructure devices occurs. Since, when acquiring configuration information from the target device, the configuration management device 200 does not have to access another device, the load on the network is suppressed compared to a method of collecting configuration information through polling or the like.

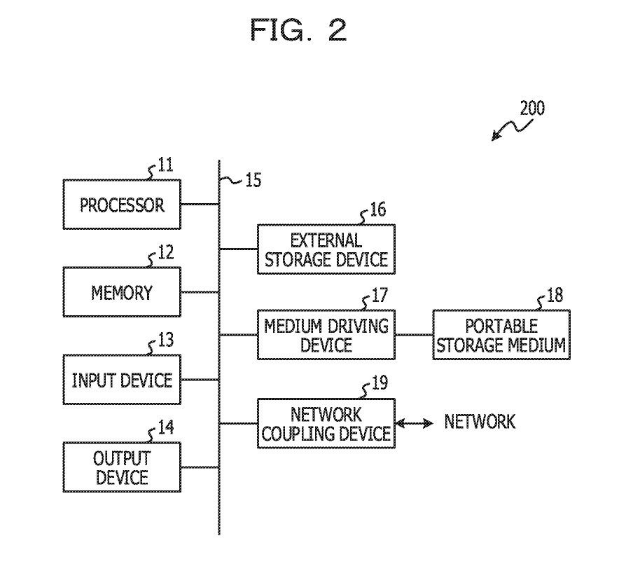

FIG. 2 is a diagram illustrating an example of a hardware configuration of a configuration management device. The configuration management device 200 includes a processor 11, a memory 12, a bus 15, an external storage device 16, and a network coupling device 19. Further, the configuration management device 200 may optionally include an input device 13, an output device 14, a medium driving device 17. The configuration management device 200 is sometimes implemented, for example, by a server, a computer, or the like.

The processor 11 may be an arbitrary processing circuit including a central processing unit (CPU). The processor 11 operates as the processing unit 204 and the determination unit 202. The processor 11 is capable of, for example, executing a program stored in the external storage device 16. The memory 12 operates as the storage unit 205. Further, the memory 12 stores data obtained by operation of the processor 11 and data for use in processing of the processor 11 as appropriate. The network coupling device 19 is used for communication with another device and operates as the receiving unit 201, the acquisition unit 203, and the instruction unit 208.

The input device 13 is implemented, for example, as a button, a keyboard, a mouse, or the like. The output device 14 is implemented as a display or the like. The bus 15 couples the processor 11, the memory 12, the input device 13, the output device 14, the external storage device 16, the medium driving device 17, and the network coupling device 19 so that they pass data to and from one another. The external storage device 16 stores programs, data, and the like and offers the stored information to the processor 11 and so on as appropriate. The medium driving device 17 is capable of outputting data in the memory 12 and the external storage device 16 to the portable storage medium 18 and reading programs, data, and so on from the portable storage medium 18. The portable storage medium 18 is any storage medium capable of being carried around, examples of which include a flexible disc, a magnet-optical (MO) disc, a compact disc recordable (CD-R), and a digital versatile disc recordable (DVD-R).

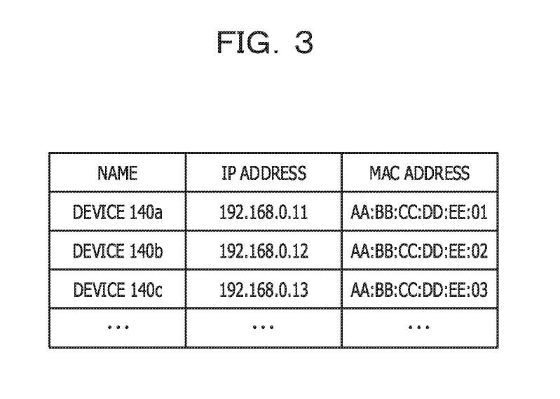

FIG. 3 is a diagram depicting an example of a device DB. The device DB 207 stores IP addresses and MAC addresses corresponding to the router 120 and the device 140a to the device 140n that the configuration management device 200 manages.

The device DB 207 includes categories of names, IP addresses, and MAC addresses. The names are the names of devices that the configuration management device 200 manages. The IP addresses are IP addresses that correspond to devices and are used on the side of the management LAN 130. The MAC addresses are MAC addresses that correspond to devices and are used on the side of the management LAN 130. For example, in the example of FIG. 3, an IP address “192.168.0.11” and a MAC address “AA:BB:CC:DD:EE:01” corresponding to the device 140a are stored in the device DB 207. An IP address “192.168.0.12” and a MAC address “AA:BB:CC:DD:EE:02” corresponding to the device 140b are stored in the device DB 207. An IP address “192.168.0.13” and a MAC address “AA:BB:CC:DD:EE:03” corresponding to the device 140c are stored in the device DB 207. An IP address is an example of a network address. A MAC address is an example of hardware identification information.

The determination unit 202 analyzes the IP address of the transmission destination (target IP address) contained in the payload in an ARP request packet and determines whether or not the IP address concerned is an IP address stored in the device DB. In such a way, the determination unit 202 may make a determination as to whether or not the device 140 to be accessed is a device being managed. Further, the determination unit 202 may determine that a configuration change for the device 140 has been made.

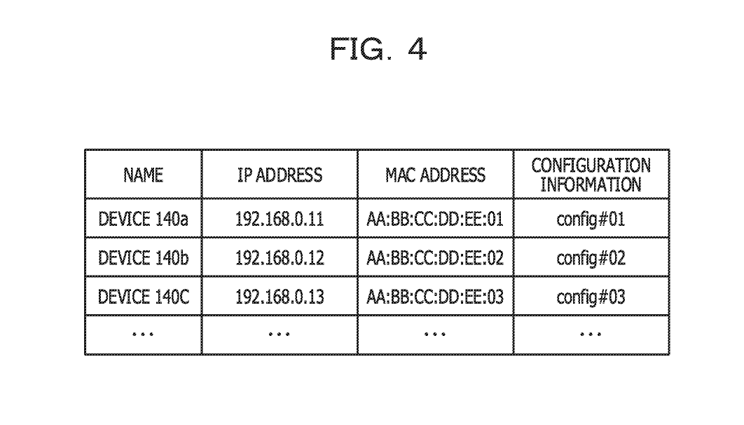

FIG. 4 is a diagram depicting an example of a configuration management DB. The configuration management DB 206 stores IP addresses and MAC addresses corresponding to the router 120 and the device 140a to the device 140n that the configuration management device 200 manages, and configuration information.

The configuration management DB 206 includes categories of names, IP addresses, MAC addresses, and configuration information. The names, the IP addresses, and the MAC addresses are categories similar to those in the device DB 207. The configuration management DB 206 stores information indicating configuration information of each device. The configuration information is acquired from the respectively corresponding devices 140 by the acquisition unit 203.

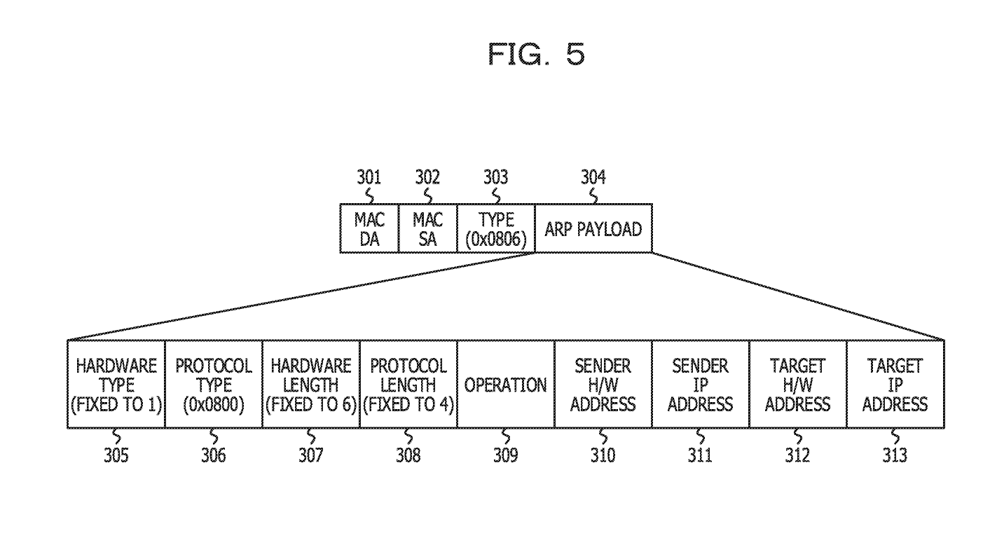

FIG. 5 is a diagram depicting an example of a format of an ARP request packet. The ARP request packet includes information such as a MAC destination address (DA) 301, a MAC source address (SA) 302, a type 303, and an ARP payload 304. Address information indicating a broadcast address is stored in the MAC DA 301. The MAC address of the router 120 is stored in the MAC SA 302. Information indicating that this packet is an ARP request packet is stored in the type 303.

The ARP payload 304 includes a hardware type 305, a protocol type 306, a hardware length 307, a protocol length 308, an operation 309, a sender hardware (H/W) address 310, a sender IP address 311, a target H/W address 312, and a target IP address 313. In the hardware type 305, information indicating the type of a network in use is stored, for example, “1” indicating Ethernet is stored. In the protocol type 306, information indicating a protocol in use for the network layer is stored, for example, 0x0800 indicating TCP/IP is stored. In the hardware length 307, information indicating the length of a MAC address, which is a hardware address, is stored. In the protocol length 308, information indicating the length of an IP address, which is a protocol address, is stored. In the operation 309, “1”, which is information indicating an ARP request is stored. In the sender H/W address 310, the MAC address of the router 120, which is the transmission source of an ARP request packet, is stored. In the sender IP address 311, the IP address of the router 120, which is the transmission source of an ARP request packet, is stored. In the target H/W address 312, the MAC address of the device 140 to be accessed is stored. However, at the time point of an address request packet, the router 120 has not acquired the MAC address, and therefore “null” indicating vacancy is stored. In the target IP address 313, the IP address of the device 140 to be accessed is stored.

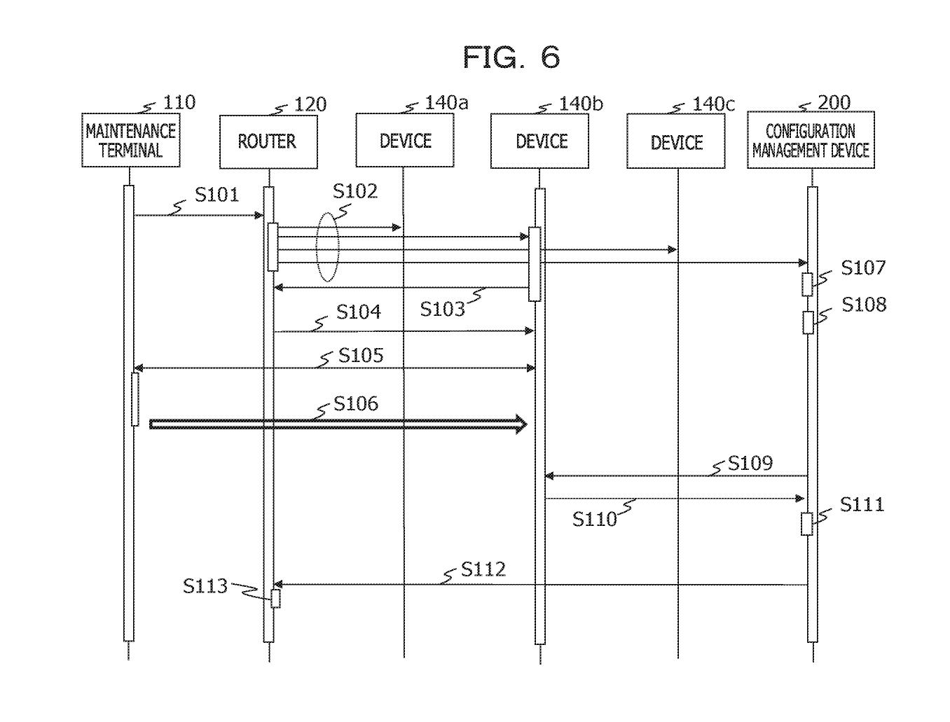

FIG. 6 is a sequence diagram illustrating an example of processing of an information processing system according to the first embodiment. The sequence diagram in FIG. 6 illustrates an example of a process performed when access from the maintenance terminal 110 to the device 140b is performed.

The maintainer inputs the IP address of the device 140b to be accessed, to the maintenance terminal 110 to attempt accessing the device 140b using secure shell (ssh). The maintenance terminal 110 transmits an access request for the device 140b to the router 120 (S101). The router 120 broadcasts an ARP request packet for acquiring the MAC address corresponding to the IP address of the device 140b included in the access request, to the device 140a to the device 140n and the configuration management device 200 on the management LAN 130 (S102). That is, the ARP request packet arrives at not only the device 140a to the device 140n but also the configuration management device 200. The ARP request packet transmitted in S102 is a packet in a format depicted in FIG. 5.

Here, the sender IP address 311 is set to the IP address of the router 120. Since, in this example, access to the device 140b is performed, the target IP address 313 is set to the IP address “192.168.0.12” of the device 140b. At this point, the MAC address corresponding to this IP address is not identified, the target H/W address 312 is “null”.

Upon receiving the ARP request packet, the device 140b transmits an ARP response packet, which is an address resolution packet, to the router 120 (S103). The ARP response packet contains the MAC address of the device 140b. The router 120, upon acquiring the MAC address of the device 140b, transmits an access request to the device 140b (S104). The router 120 establishes a session from the maintenance terminal 110 to the device 140b (S105). The maintainer changes the configuration of the device 140b through the maintenance terminal 110 (S106).

Having received the ARP request packet through the broadcast to the device 140a to the device 140n and the configuration management device 200 performed in S102, the configuration management device 200 starts execution of the process in and after S107 in parallel to the process in S103. The determination unit 202 of the configuration management device 200 analyzes the IP address of the transmission source (the sender IP address 311) of the ARP request packet using the device DB 207 and determines whether or not the transmission source is the router 120 (S107). The determination unit 202 analyzes the IP address of the transmission destination (the target IP address 313) included in the payload in the ARP request packet. Further, the determination unit 202 determines whether or not the device 140b serving as the destination is a device being managed by the configuration management device 200 (S108).

In this example, the sender IP address 311 of the ARP request packet is set to the IP address of the router 120. Therefore, the determination unit 202 determines that the transmission source of the ARP request packet is the router 120. Further, the target IP address 313 of the ARP request packet is set to “192.168.0.12”. Therefore, with reference to the device DB 207 depicted in FIG. 3, the determination unit 202 determines that the destination of the ARP request packet (that is, the device 140b) is a device being managed by the configuration management device 200.

The acquisition unit 203 transmits an acquisition request for the latest configuration information to the device 140b identified in S108 (S109). The process in S109 is executed by the acquisition unit 203 after the acquisition unit 203 has been in a standby state for a given period of time after the process in S108. It is preferable that the “given period of time” be, for example, longer than the estimated working hours for maintenance performed by the maintainer. In response to the request from the configuration management device 200, the device 140b transmits the latest configuration information to the acquisition unit 203 of the configuration management device 200 (S110). The processing unit 204 causes the configuration management DB 206 in the storage unit 205 to reflect the acquired configuration information (S111).

The process in S111 results in that the processing unit 204 stores the acquired configuration information “config#02” of the device 140b in association with the device 140b, as depicted in the configuration management DB 206 in FIG. 4. Thereafter, the instruction unit 208 transmits an instruction to delete an entry related to the device 140b included in the ARP table 121 in the router 120, to the router 120 (S112). The router 120 carries out the received instruction to delete the entry in the ARP table 121 related to the device 140b (S113).

The configuration management device 200 may detect that a configuration change will be made for the device 140 being managed and to be accessed, by analyzing the ARP request packet transmitted from the router 120. Thereafter, the configuration management device 200 acquires the latest configuration information from the device 140. Thus, it is possible to reduce the period of time during which inconsistency between the configuration information managed by the configuration management system and the actual configuration information of the infrastructure devices occurs.

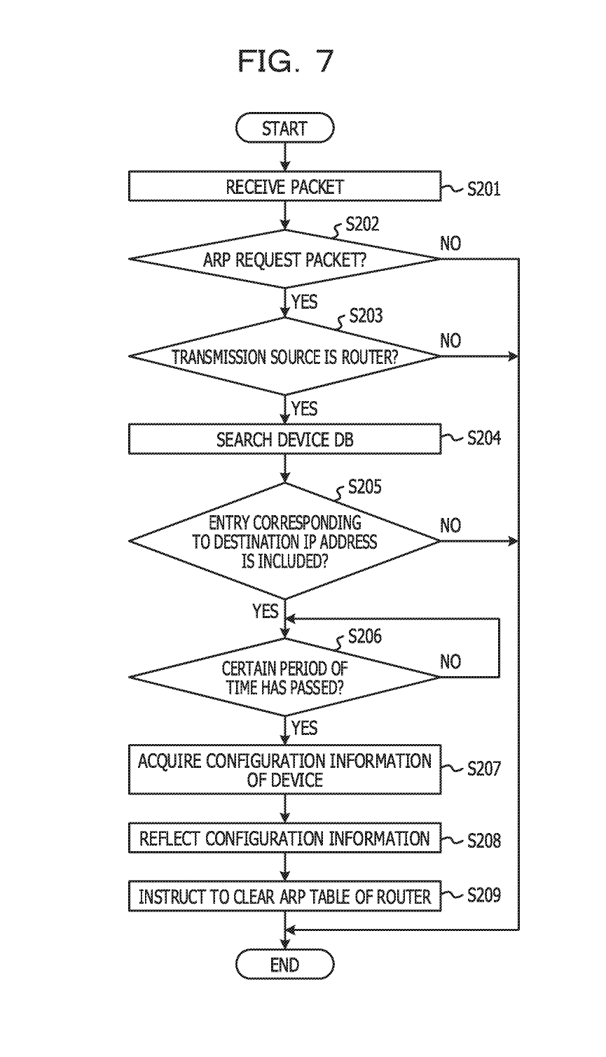

FIG. 7 is a flowchart illustrating an example of processing of a configuration management device according to the first embodiment. The receiving unit 201 in the configuration management device 200 receives a packet transmitted from the router 120 (S201). The determination unit 202 determines whether or not the received packet is an ARP request packet (S202). If the received packet is not an ARP request packet (No in S202), the configuration management device 200 terminates the process according to the first embodiment. On the other hand, if the received packet is an ARP request packet (Yes in S202), the determination unit 202 determines whether or not the transmission source of the ARP request packet is the router 120 (S203). If the transmission source of the ARP request packet is not the router 120 (No in S203), the configuration management device 200 terminates the process according to the first embodiment. On the other hand, if the transmission source of the ARP request packet is the router 120 (Yes in S203), the determination unit 202 searches the device DB 207 using the destination IP address of the ARP payload (S204). The determination unit 202 determines whether or not there is an entry corresponding to the destination IP address in the device DB 207 (S205). If there is no entry corresponding to the destination IP address in the device DB 207 (No in S205), the configuration management device 200 terminates the process according to the first embodiment.

On the other hand, if there is an entry corresponding to the destination IP address in the device DB 207 (Yes in S205), the acquisition unit 203 determines whether or not a certain period of time has passed after the process in S205 (S206). If the certain period of time has not passed after the process in S205 (No in S206), the acquisition unit 203 repeats the process in S206. On the other hand, if the certain period of time has passed after the process in S205 (Yes in S206), the acquisition unit 203 acquires the configuration information of the device 140 to be accessed (S207). The processing unit 204 causes the configuration management DB 206 in the storage unit 205 to reflect the acquired configuration information (S208). The instruction unit 208 transmits an instruction to delete an entry related to the device 140 to be accessed included in the ARP table 121 in the router 120, to the router 120 (S209). Upon completion of the process in S209, the configuration management device 200 completes the process according to the first embodiment.

The configuration management device 200 may detect that a configuration change will be made for the device 140 being managed and to be accessed, by analyzing an ARP request packet transmitted from the router 120. Thereafter, the configuration management device 200 acquires the latest configuration information from the device 140, and thus may reduce the period of time during which inconsistency between the configuration information managed by the configuration management system and the actual configuration information of the infrastructure devices.

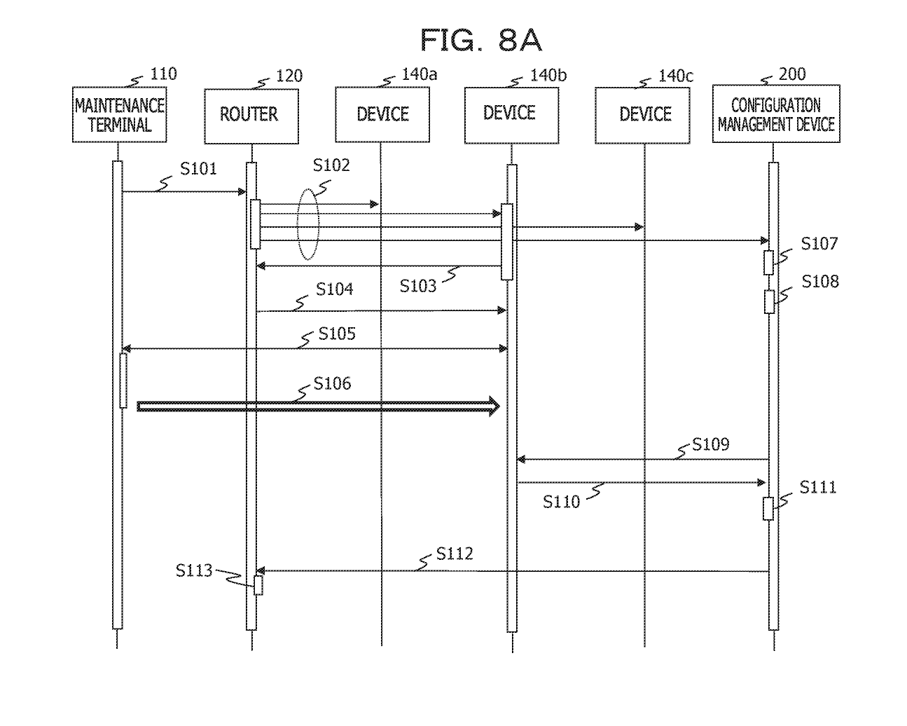

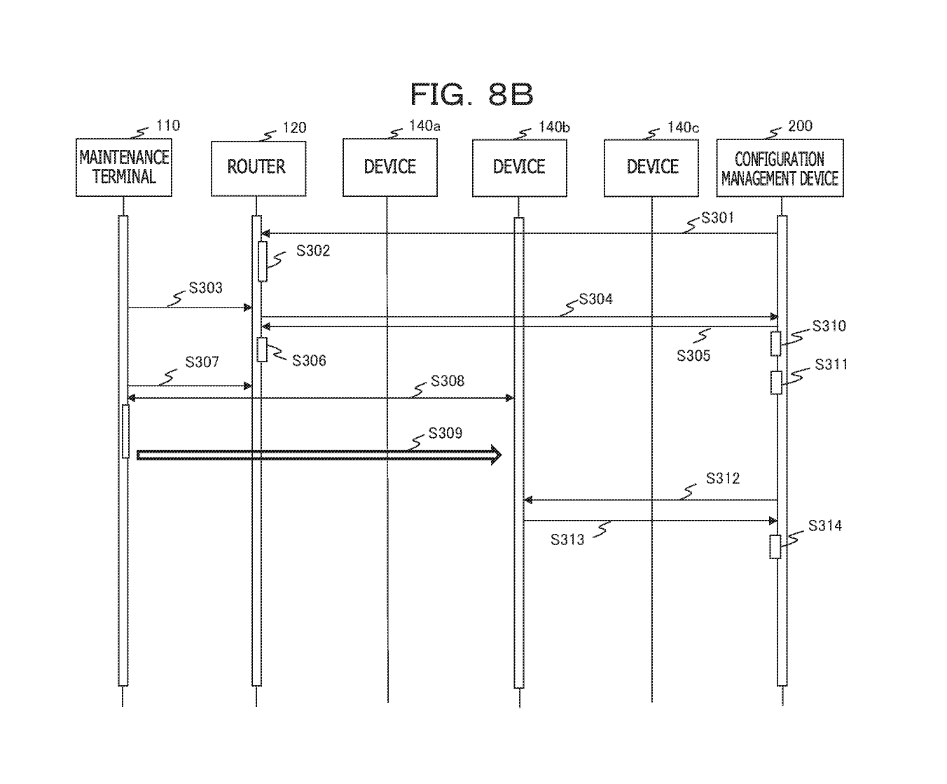

FIG. 8A and FIG. 8B are sequence diagrams illustrating an example of processing of an information processing system according to a second embodiment. The information processing system according to the second embodiment has a configuration similar to that in FIG. 1 illustrating an example of the information processing system according to the first embodiment. Therefore, the same components as in FIG. 1 are denoted by the same reference numerals.

The processing of the information processing system according to the second embodiment and the processing of the information processing system according the first embodiment are the same in the process in S101 to S111 in FIG. 6. In the processing of the information processing system according to the second embodiment, the configuration management device 200 uses a gratuitous ARP (GARP) as an alternative to the processing of deleting the ARP table 121 of the router 120. An example of the process of the information processing system according to the second embodiment using a GARP packet will be described below. The process in S101 to S111 is similar to that in FIG. 6 and therefore the description thereof is omitted.

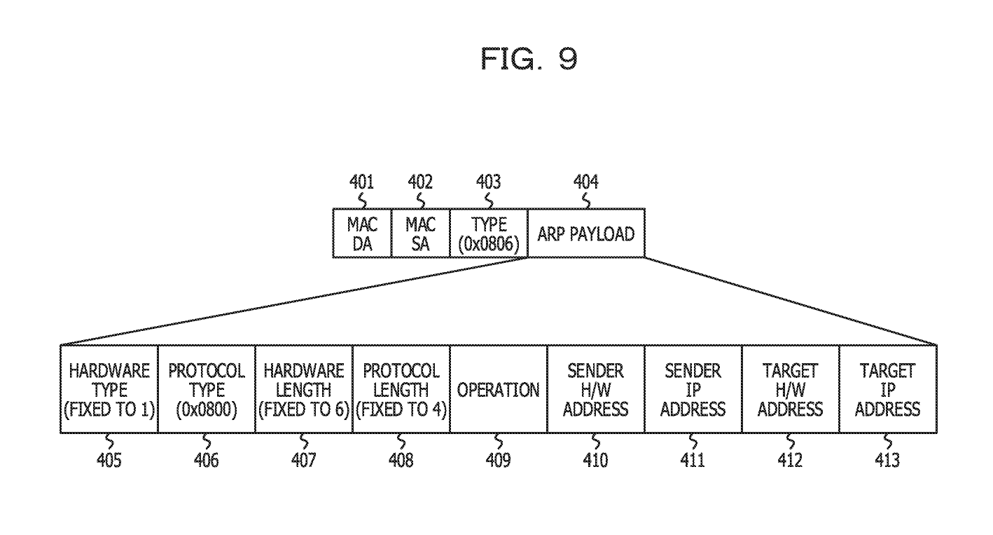

Upon completion of the process in S111, the instruction unit 208 of the configuration management device 200 transmits a GARP packet 1 (described in detail with reference to FIG. 9) in order to update the ARP table 121 of the router 120 (S301). The router 120 updates the ARP table 121 based on the received GARP packet 1 (S302). Here, the GARP packet 1 contains the IP address of the device 140b for which a change in setting has been made by the maintainer, and the MAC address of the configuration management device 200. Thus, the IP address of the device 140b and the MAC address of the configuration management device 200 are set in association with each other in the ARP table 121 of the router 120. Thereby, if, next, the maintainer attempts accessing the device 140b using ssh, an ssh message requesting ssh access is transferred to the configuration management device 200.

If there is access to the device 140b using ssh (the second time), the maintenance terminal 110 transmits an access request for the device 140b to the router 120 (S303). The router 120 transmits an ssh message requesting access, to the configuration management device 200 (S304). Upon detecting the request for access, the instruction unit 208 of the configuration management device 200 transmits a GARP packet 2 (described in detail with reference to FIG. 9) to the router 120 (S305). The router 120 updates the ARP table 121 based on the received GARP packet 2 (S306). The GARP packet 2 contains the IP address of the device 140b for which a change in setting has been made by the maintainer, and the MAC address of the device 140b. Thus, the IP address of the device 140b and the MAC address of the device 140b are stored in association with each other in the ARP table 121 of the router 120. Since the access request in S303 does not result in access to the device 140b, the maintenance terminal 110 fails in processing and times out.

The maintenance terminal 110 transmits an access request for the device 140b to the router 120 by retry processing (S307). The router 120, upon acquiring the MAC address of the device 140b, establishes a session from the maintenance terminal 110 to the device 140b (S308). The maintainer changes the configuration of the device 140b through the maintenance terminal 110 (S309).

The configuration management device 200, upon receiving the ssh message in S304, starts execution of the process in and after S310 in parallel to the process in S306 and so on. The determination unit 202 of the configuration management device 200 analyzes the received ssh message and determines whether or not the transmission source is the router 120 (S310). The ssh message contains the IP addresses of the transmission source router 120 and the device 140 to be accessed. The determination unit 202 analyzes the IP address of the transmission destination in the ssh message. Then, the determination unit 202 determines whether or not the device 140b serving as the destination is a device being managed by the configuration management device 200 (S311). The acquisition unit 203 transmits a request for acquiring the latest configuration information to the device 140b (S312). The process in S312 is executed by the acquisition unit 203 after the acquisition unit 203 has been in a standby state for a given period of time after the process in S311. The device 140b transmits the latest configuration information to the acquisition unit 203 of the configuration management device 200 (S313). The processing unit 204 causes the configuration management DB 206 in the storage unit 205 to reflect the acquired configuration information (S314).

Through the process in S301 to S314, the process as in the first embodiment may be executed without deleting or initializing the ARP table 121. The configuration management device 200 may detect that a configuration change will be made for the device 140 being managed and to be accessed, by analyzing an ssh message transmitted from the router 120. Thereafter, the configuration management device 200 acquires the latest configuration information from the device 140 and thus may reduce the period of time during which inconsistency between the configuration information managed by the configuration management system and the actual configuration information of infrastructure devices occurs.

FIG. 9 is a diagram illustrating an example of a format of a GARP packet. The GARP packet has a format similar to the format of the ARP request packet in FIG. 5. The GARP packet 1 and the GARP packet 2 both contain information such as a MAC DA 401, a MAC SA 402, a type 403, and an ARP payload 404. The MAC address of the router 120 is stored in the MAC DA 401. The MAC address of the configuration management device 200 is stored in the MAC SA 402. Information indicating that this packet is an ARP request packet may be stored in the type 403.

The ARP payload 404 includes a hardware type 405, a protocol type 406, a hardware length 407, a protocol length 408, an operation 409, a sender H/W address 410, a sender IP address 411, a target H/W address 412, and a target IP address 413. The hardware type 405, the protocol type 406, the hardware length 407, and the protocol length 408 are similar as in FIG. 5 and therefore the description of these components is omitted.

The operations 409 of the GARP packet 1 and the GARP packet 2 both store “2”, which is information indicating an ARP response in response to an ARP request. The MAC address of the configuration management device 200 is stored in the sender H/W address 410 and the target H/W address 412 of the GARP packet 1. The IP address of the device 140 to be accessed is stored in the sender IP address 411 and the target IP address 413 of the GARP packet 1.

The MAC address of the device 140 to be accessed, which is stored in the device DB 207, is stored in the sender H/W address 410 and the target H/W address 412 of the GARP packet 2. The IP address of the device 140 to be accessed, which is stored in the device DB 207, is stored in the sender IP address 411 and the target IP address 413 of the GARP packet 2.

The router 120 implements the information processing system according to the second embodiment by updating the ARP table 121 based on the GARP packet 1 and the GARP packet 2.

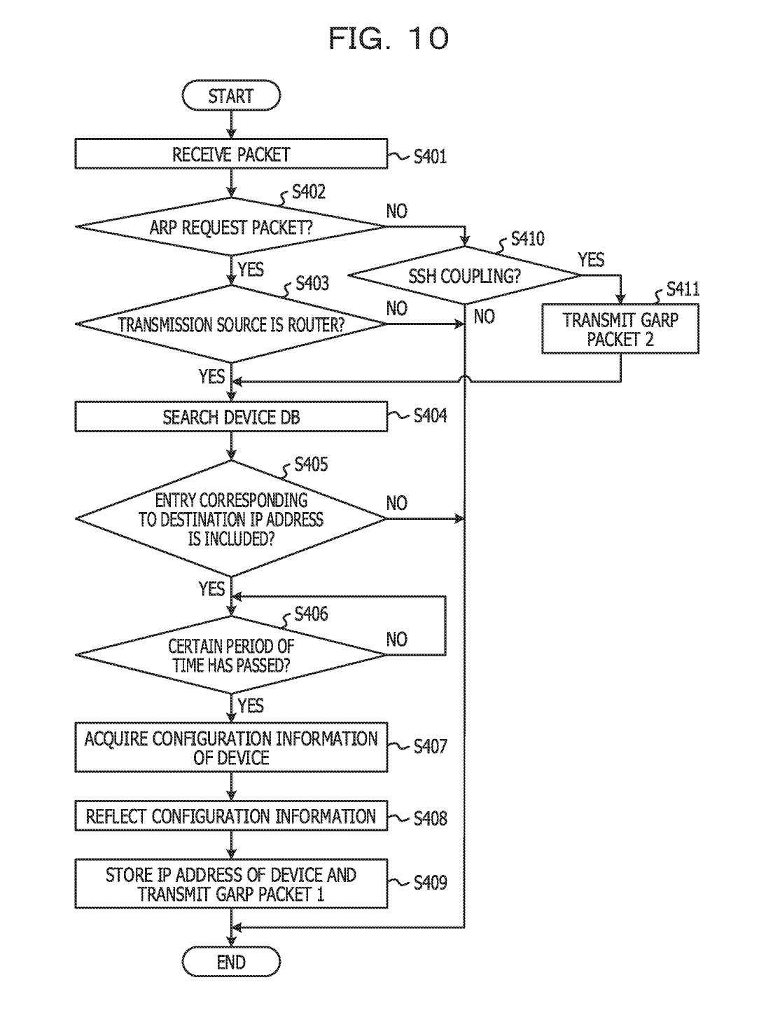

FIG. 10 is a flowchart illustrating an example of processing of the information processing system according to the second embodiment. The receiving unit 201 in the configuration management device 200 receives a packet transmitted from the router 120 (S401). The determination unit 202 determines whether or not the received packet is an ARP request packet (S402). If the received packet is an ARP request packet (Yes in S402), then the determination unit 202 determines whether or not the transmission source of the ARP request packet is the router 120 (S403). If the transmission source of the ARP request packet is not the router 120 (No in S403), the configuration management device 200 terminates the process according to the second embodiment. On the other hand, if the transmission source of the ARP request packet is the router 120 (Yes in S403), the determination unit 202 searches the device DB 207 using the destination IP address of the ARP payload (S404). The determination unit 202 determines whether or not there is an entry corresponding to the destination IP address in the device DB 207 (S405). If there is no entry corresponding to the destination IP address in the device DB 207 (No in S405), the configuration management device 200 terminates the process according to the second embodiment.

On the other hand, there is an entry corresponding to the destination IP address in the device DB 207 (Yes in S405), the acquisition unit 203 determines whether or not a certain period of time has passed after the process in S405 (S406). If the certain period of time has not passed after the process in S405 (No in S406), the acquisition unit 203 repeats the process in S406. On the other hand, if the certain period of time has passed after the process in S405 (Yes in S406), the acquisition unit 203 acquires the configuration information of the device 140 to be accessed (S407). The processing unit 204 causes the configuration management DB 206 in the storage unit 205 to reflect the acquired configuration information (S408). The processing unit 204 temporarily stores the IP address and the MAC address of the device 140. Further, the instruction unit 208 transmits the GARP packet 1 including the IP address and the MAC address of the configuration management device 200 to the router 120 (S409). Upon completion of the process in S409, the configuration management device 200 completes the process according to the second embodiment.

If the received packet is not an ARP request packet (No in S402), the determination unit 202 determines whether or not coupling using ssh is provided (S410). If ssh coupling is provided (Yes in S410), the instruction unit 208 transmits the GARP packet 2 including the IP address and the MAC address of the device for which a change in setting has been made, to the router 120 (S411). Upon completion of the process in S411, the configuration management device 200 executes the process from S404. When the process in S404 is executed subsequently to the process in S411, the process is executed using the IP address in an ssh message.

Through the process in S401 to S411, the process as in the first embodiment may be executed without deleting or initializing the ARP table 121. The configuration management device 200 may detect that a configuration change will be made for the device 140 being managed and to be accessed, by analyzing an ssh message transmitted from the router 120. Thereafter, the configuration management device 200 acquires the latest configuration information from the device 140 and thus may reduce the period of time during which inconsistency between the configuration information managed by the configuration management system and the actual configuration information of infrastructure devices occurs.

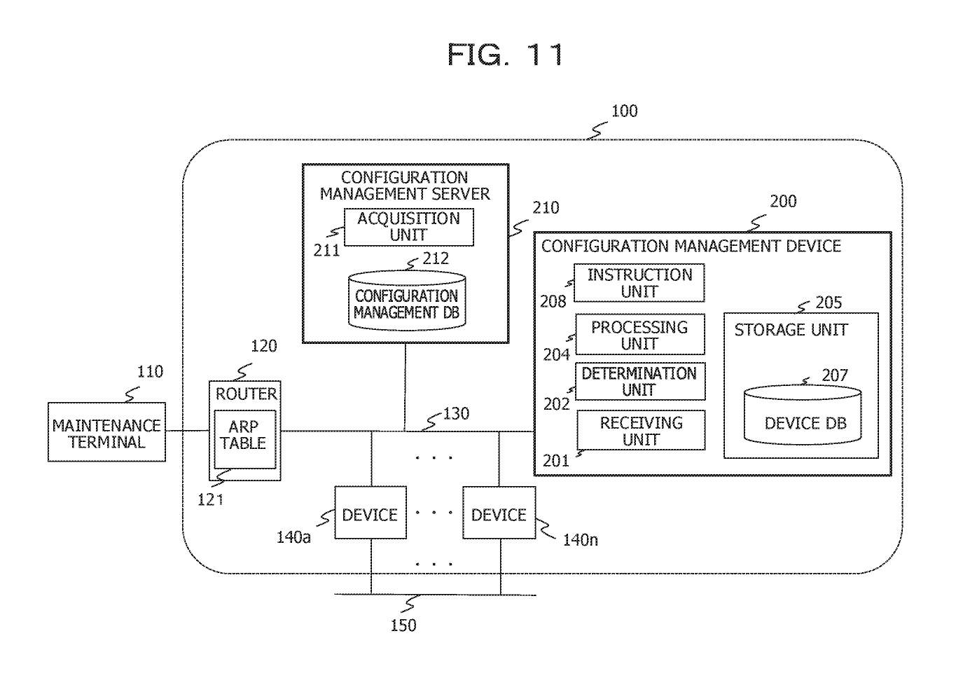

FIG. 11 is a diagram illustrating an example of an information processing system according to a third embodiment. In FIG. 11, components in a configuration similar to that in FIG. 1 are denoted by the same reference numerals. The configuration management device 200 in the third information processing system 100 neither include the acquisition unit 203 nor the configuration management DB 206. In the information processing system 100 according to the third embodiment, an acquisition unit 211 and a configuration management DB 212, which are alternatives to the acquisition unit 203 and the configuration management DB 206, are provided as a configuration management server 210 outside the configuration management device 200.

If the transmission source of an ARP request packet is the router 120 and the destination IP address is the IP address of the device 140 being managed by the configuration management device 200, the determination unit 202 determines that a configuration change for the device 140 has been made. The instruction unit 208 transmits a request for acquiring the configuration information of the device 140 of the destination IP address contained in the ARP request packet to the acquisition unit 211 of the configuration management server 210. The acquisition unit 211 acquires the latest configuration information from the device 140 to be accessed, according to the request for acquiring the configuration information. The acquisition unit 211 acquires the latest configuration information from the device 140 and causes the configuration management DB 212 to reflect the configuration information.

The configuration management server 210 is, for example, a server capable of regularly acquiring the latest configuration information of the device 140. Coupling the configuration management device 200 to the configuration management server 210 makes it possible to readily implement the information processing system according to the third embodiment. The configuration management device 200 may detect that a configuration change will be made for the device 140 being managed and to be accessed, by analyzing an ARP request packet transmitted from the router 120. Thereafter, the configuration management server 210 acquires the latest configuration information from the device 140 and thus may reduce the period of time during which inconsistency between the configuration information managed by the configuration management server 210 and the actual configuration information of infrastructure devices occurs. Since, when acquiring configuration information from the target device, the configuration management server 210 does not have to access another device, the load on the network is suppressed compared to a method of collecting configuration information through polling or the like.

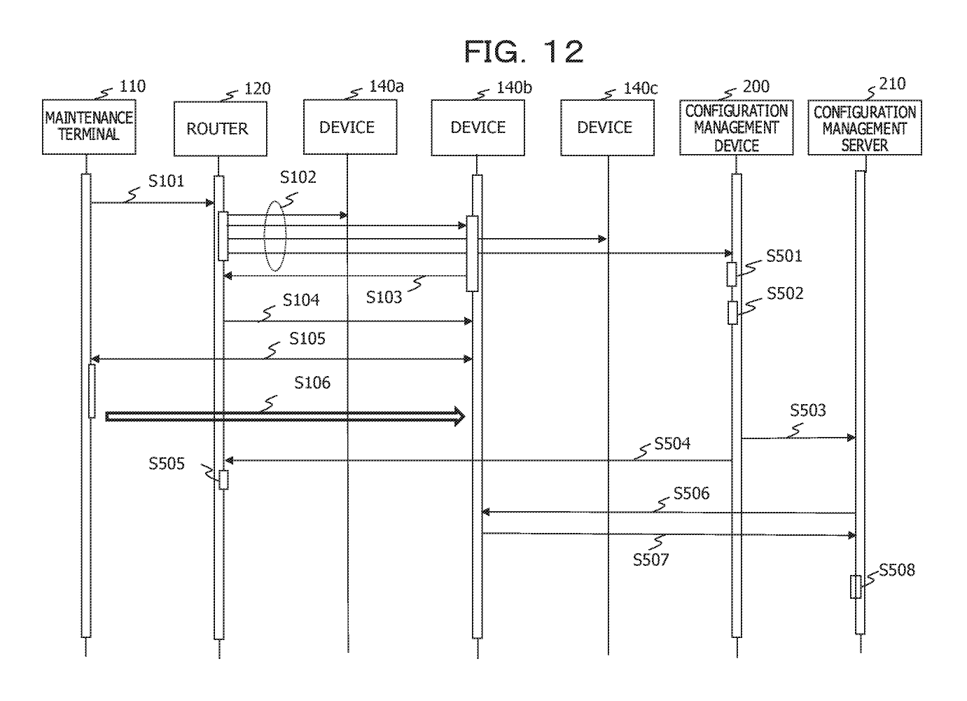

FIG. 12 is a sequence diagram illustrating an example of processing of the information processing system according to the third embodiment. The process in S101 to S106 in FIG. 12 is the same as the process in S101 to S106 in FIG. 6.

Having received an ARP request packet through the broadcast to the device 140a to the device 140n and the configuration management device 200 performed in S102, the configuration management device 200 starts execution of the process in and after S501 in parallel to the process in S103. The determination unit 202 of the configuration management device 200 analyzes the IP address (the sender IP address 311) of the transmission source of the ARP request packet and determines whether or not the transmission source is the router 120 (S501). The determination unit 202 analyzes the IP address of the transmission destination (the target IP address 313) included in the payload in the ARP request packet. The determination unit 202 then determines whether or not the destination device 140b is a device being managed by the configuration management device 200 (S502). The device 140 being managed is stored in the device DB 207.

The instruction unit 208 notifies the acquisition unit 211 of the configuration management server 210 of the IP address of the 140b accessed (S503). The process in S503 is executed by the instruction unit 208 after the instruction unit 208 has been in a standby state for a given period of time after the process in S502. The instruction unit 208 transmits, to the router 120, an instruction to delete an entry related to the device 140b included in the ARP table 121 in the router 120 (S504). The router 120 executes the received instruction to delete the entry in the ARP table 121 related to the device 140b (S505).

The acquisition unit 211 of the configuration management server 210 transmits a request for the latest configuration information to the device 140b (S506). The device 140b transmits the latest configuration information to the acquisition unit 211 of the configuration management server 210 (S507). The acquisition unit 211 causes the configuration management DB 212 to reflect the acquired configuration information (S508). The process in S504 to S505 and the process in S506 to S508 may be executed in parallel.

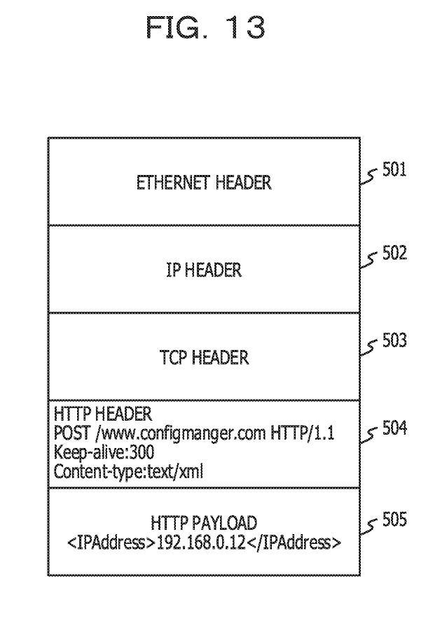

FIG. 13 is a diagram depicting an example of information transmitted from the configuration management device to the configuration management server. The instruction unit 208 of the configuration management device 200 transmits an IP address notification message including the IP address of the device 140 to be accessed, to the acquisition unit 211 of the configuration management server 210.

The IP address notification message contains an Ethernet header 501, an IP header 502, a TCP header 503, an HTTP header 504, and an HTTP payload 505. Information indicating that Ethernet is used for transmission of an IP address notification message is stored in the Ethernet header 501. The IP address of the configuration management device 200 serving as the transmission source is stored in the IP header 502. Information indicating that the TCP protocol is used for transmission of an IP address notification message is stored in the TCP header 503. Information indicating the URL of the acquisition unit 211 of the configuration management server 210 is stored in the HTTP header 504. The IP address of the device 140 to be accessed is included in the HTTP payload 505.

The instruction unit 208 specifies an URL indicating the acquisition unit 211 contained in the HTTP header 504 to notify the acquisition unit 211 of the configuration management server 210 of the IP address of the device 140b to be accessed contained in the HTTP payload.

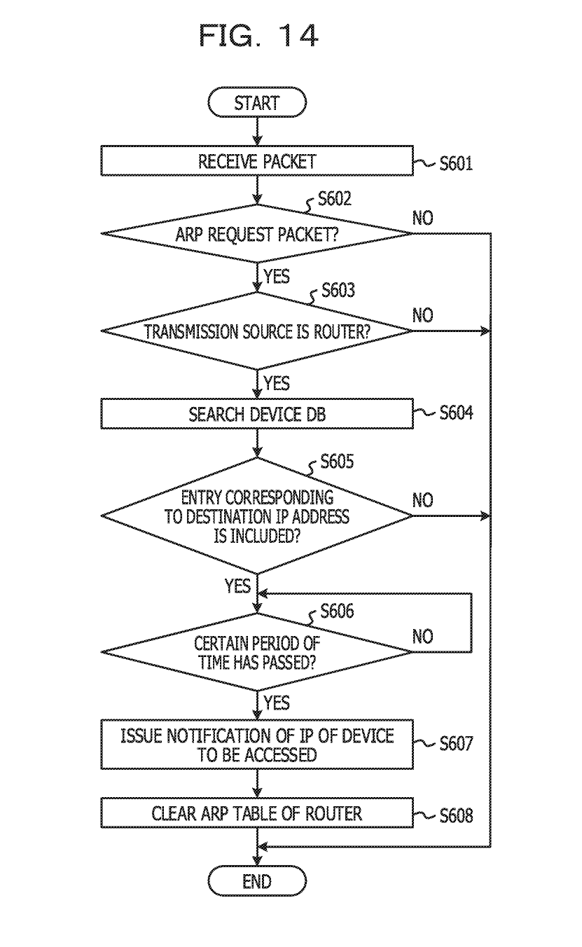

FIG. 14 is a flowchart illustrating an example of processing of the configuration management device according to the third embodiment. The process in S601 to S606, which is the process executed by the configuration management device 200 according to the third embodiment, are the same as the process in S201 to S206, which is the process executed by the configuration management device 200 according to the first embodiment in FIG. 7.

Upon completion of the process in S606, the instruction unit 208 of the configuration management device 200 transmits an IP address notification message to the acquisition unit 211 of the configuration management server 210 (S607). The instruction unit 208 transmits, to the router 120, an instruction to delete an entry related to the device 140 to be accessed, the entry being included in the ARP table 121 in the router 120 (S608).

The configuration management device 200 may detect that the configuration of the device 140 being managed and to be accessed, by analyzing an ARP request packet transmitted from the router 120. Thereafter, the configuration management server 210 acquires the latest configuration information from the device 140 and thus may reduce the period of time during which inconsistency between the configuration information managed by the configuration management server 210 and the actual configuration information of infrastructure devices occurs. The configuration management server 210 does not have to access another device when acquiring configuration information from the target device. Therefore, the load on the network is suppressed compared to a method of collecting configuration information through polling or the like.

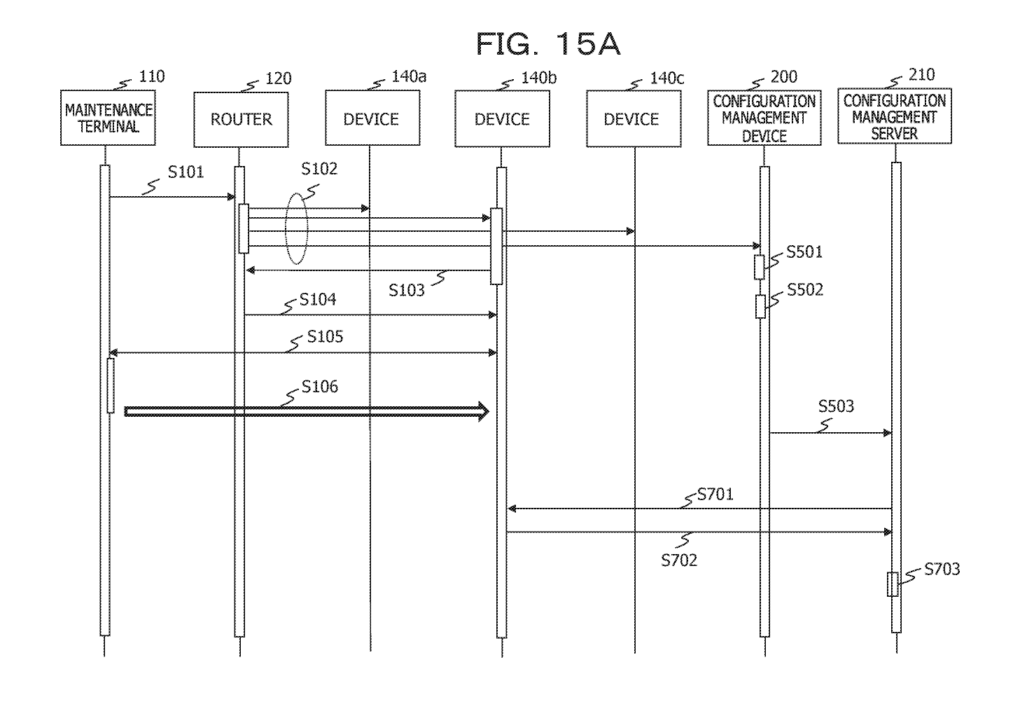

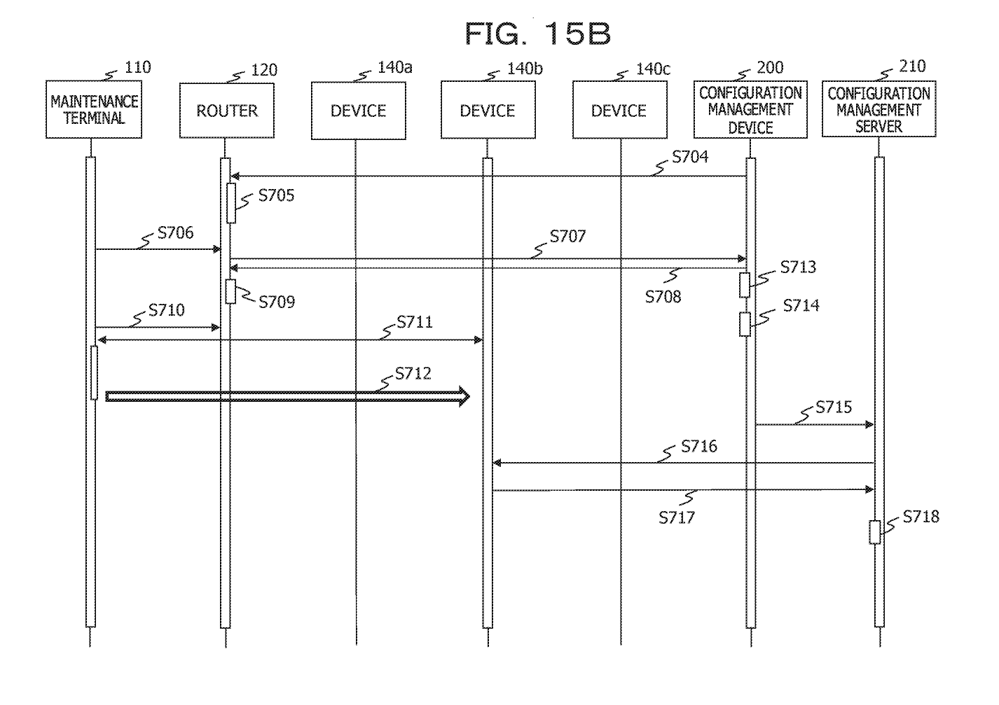

FIG. 15A and FIG. 15B are sequence diagrams illustrating an example of processing of an information processing system according to a fourth embodiment. Like the information processing system 100 in FIG. 11, the information processing system according to the fourth embodiment includes the configuration management device 200 and the configuration management server 210 for the purpose of managing the devices 140. The processing of the information processing system according to the fourth embodiment and the processing of the information processing system according to the third embodiment are the same in the process in S101 to S106 and in S501 to S503. In the processing of the information processing system according to the fourth embodiment, the configuration management device 200 uses a GARP as an alternative to processing of deleting the ARP table 121 of the router 120. An example of processing of the information processing system according to the fourth embodiment using a GARP packet will be described below. The process in S101 to S106 and S501 to S503 is similar to that in FIG. 11 and the description thereof is omitted.

The acquisition unit 211 of the configuration management server 210 transmits a request for acquiring the latest configuration information to the device 140b (S701). The device 140b transmits the latest configuration information to the acquisition unit 211 of the configuration management server 210 (S702). The acquisition unit 211 causes the configuration management DB 212 to reflect the acquired configuration information (S703).

Upon completion of the process in S703, the instruction unit 208 of the configuration management device 200 transmits the GARP packet 1 in order to update the ARP table 121 of the router 120 (S704). The router 120 updates the ARP table 121 based on the received GARP packet 1 (S705). The GARP packet 1 contains the IP address of the device 140b for which a change in setting has been made by the maintainer, and the MAC address of the configuration management device 200. Thus, the IP address of the device 140b and the MAC address of the configuration management device 200 are set in association with each other in the ARP table 121 of the router 120. Then, when, next, the maintainer attempts accessing the device 140b using ssh, an ssh message requesting ssh access is transferred to the configuration management device 200.

If there is access to the device 140b using ssh (the second time), the maintenance terminal 110 transmits an access request for the device 140b to the router 120 (S706). The router 120 transmits an ssh message requesting access, to the configuration management device 200 (S707). Upon detecting the request for access, the instruction unit 208 of the configuration management device 200 transmits the GARP packet 2 to the router 120 (S708). The router 120 updates the ARP table 121 based on the received GARP packet 2 (S709). The GARP packet 2 contains the IP address of the device 140b for which a change in setting has been made by the maintainer, and the MAC address of the device 140b. Thus, the IP address of the device 140b and the MAC address of the device 140b are stored in association with each other in the ARP table 121 of the router 120. Since the access request in S706 does not result in access to the device 140b, the maintenance terminal 110 fails in processing and times out.

The maintenance terminal 110 transmits an access request for the device 140b to the router 120 by retry processing (S710). The router 120, upon acquiring the MAC address of the device 140b, establishes a session from the maintenance terminal 110 to the device 140b (S711). The maintainer changes the configuration of the device 140b through the maintenance terminal 110 (S712).

The configuration management device 200, upon receiving the ssh message in S707, starts execution of the process in and after S713 in parallel to the process in S709 and so on. The determination unit 202 of the configuration management device 200 analyzes the received ssh message and determines whether or not the transmission source is the router 120 (S713). The ssh message contains the IP addresses of the transmission source router 120 and the device 140 to be accessed. The determination unit 202 analyzes the IP address of the transmission destination in the ssh message. Then, the determination unit 202 determines whether or not the device 140b serving as the destination is a device being managed by the configuration management device 200 (S714).

The instruction unit 208 notifies the acquisition unit 211 of the configuration management server 210 of the IP address of the device 140b accessed (S715). The process in S715 is executed by the instruction unit 208 after the instruction unit 208 has been in a standby state for a given period of time after the process in S714. The acquisition unit 211 of the configuration management server 210 transmits a request for acquiring the latest configuration information to the device 140b (S716). The device 140b transmits the latest configuration information to the acquisition unit 211 of the configuration management server 210 (S717). The acquisition unit 211 causes the configuration management DB 212 to reflect the acquired configuration information (S718).

Through the process in S701 to S718, the process as in the third embodiment may be executed without deleting or initializing the ARP table 121. The configuration management device 200 may detect that a configuration change will be made for the device 140 being managed and to be accessed, by analyzing an ssh message transmitted from the router 120. Thereafter, the configuration management device 200 acquires the latest configuration information from the device 140 and thus may reduce the period of time during which inconsistency between the configuration information managed by the configuration management system and the actual configuration information of infrastructure devices occurs.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing system, comprising:
a plurality of devices coupled to one another via a network;
a relay device coupled to a terminal device and configured to relay communication between the terminal device and the plurality of devices; and
a management device configured to manage the plurality of devices and the relay device,
wherein the relay device is configured to:
receive an access request for requesting access to a target device from the terminal device, and
broadcast a request packet for acquiring identification information that identifies the target device to the network, the request packet including a network address of the target device, and
wherein the management device is configured to:
receive the request packet,
identify the target device out of the plurality of devices, based on the network address included in the request packet,
acquire configuration information from the identified target device, and
update configuration management information including configuration information of each of the plurality of devices using the acquired configuration information.

2. The information processing system according to claim 1,
wherein the relay device includes an association information table for storing a plurality of entries, each of the plurality of entries including a combination of a network address and identification information that identifies hardware, and
the relay device is configured to broadcast the request packet when the identification information corresponding to a network address of the target device is not present in the correspondence information table.

3. The information processing system according to claim 2,
wherein the management device is configured to initialize information included in an entry corresponding to the target device among the plurality of entries in the association information table after updating the configuration management information.

4. The information processing system according to claim 3,
wherein the management device is configured to delete information included in an entry corresponding to the target device among the plurality of entries after updating the configuration management information.

5. The information processing system according to claim 2,
wherein the management device is configured to:
set the identification information of the management device in an entry corresponding to the target device among the plurality of entries in the association information table after updating the configuration management information, and
transmit, to the relay device, the identification information and the network address that correspond to the target device and are included in the configuration management information when an access request for the target device is received from the relay device.

6. The information processing system according to claim 1,
wherein the management device is configured to acquire configuration information from the identified target device after a given period of time has elapsed since identification of the target device.

7. The information processing system according to claim 6,
wherein the given period of time is determined based on a period of time during which the terminal device is operated by a user.

8. The information processing system according to claim 1,
wherein the identification information is a media access control (MAC) address.

9. An information processing method executed by an information processing system including a plurality of devices coupled to one another via a network, a relay device coupled to a terminal device and configured to relay communication between the terminal device and the plurality of devices, and a management device configured to manage the plurality of devices and the relay device, comprising:
receiving, by the relay device, an access request for requesting access to a target device from the terminal device;
broadcasting a request packet for acquiring identification information that identifies the target device to the network, the request packet including a network address of the target device;
receiving, by the management device, the request packet;
identifying the target device out of the plurality of devices based on the network address included in the request packet;
acquiring configuration information from the identified target device; and
updating configuration management information including configuration information of each of the plurality of devices using the acquired configuration information.

10. A non-transitory computer-readable storage medium storing a program that causes a processor included in a management device to execute a process, the management device being configured to manage a plurality of devices coupled to one another via a network, and a relay device coupled to a terminal device and configured to relay communication between the terminal device and the plurality of devices, the process comprising:
receiving, from the terminal device, a request packet broadcast from the relay device to the network in response to receipt of an access request for requesting access to a target device, the request packet including a network address of the target device and being a packet for acquiring identification information that identifies the target device;
identifying the target device out of the plurality of devices based on a network address included in the request packet;
acquiring configuration information from the identified target device; and
updating configuration management information including configuration information of each of the plurality of devices using the acquired configuration information.
